(19) United States
(12) Patent Application Publication
(10) Pub. No.: US 2018/0291235 A1
(43) Pub. Date: Oct. 11, 2018

(54) WATER-ACTIVATED DOUBLE-SIDED ADHESIVE TAPE OR SHEET

(71) Applicant: KURAMOTO SANGYO CO., Tokyo, (JP)

(72) Inventors: Yuji OHMORI, Tokyo (JP); Kyoko UMETSU, Tokyo (JP)

(73) Assignees: KURAMOTO SANGYO CO., Tokyo (JP); KURAMOTO SANGYO CO., Tokyo (JP)

(21) Appl. No.: 15/574,124

(22) PCT Filed: May 13, 2016
(86) PCT No.: PCT/JP2016/064233

§ 371 Date: Nov. 14, 2017

(30) Foreign Application Priority Data
May 15, 2015 (JP) 2015-099963

(51) Int. Cl. C09J 7/21; B32B 5/02; B32B 27/12; B32B 27/30; B32B 23/10

(52) U.S. Cl. CPC C09J 7/21; B32B 5/024; B32B 27/12; A63B 53/14; B32B 23/10; B32B 2307/726; B32B 2405/00; B32B 27/308

(57) ABSTRACT

Provided is a water-activated double-side adhesive tape or sheet, wherein a water-absorbing adhesive layer is provided on one surface of a water permeable substrate, and a water-activated adhesive layer which is made slippery by applying water is provided on the other surface of the water permeable substrate. The water-activated double-sided adhesive tape or sheet is used to fix grips onto sports equipment such as golf clubs and bicycle, and allows the adhesive layer to dry rapidly and the grips to be fixed well, regardless of the type of grip material.

### TECHNICAL FIELD

The present invention relates to a water-activated double-sided adhesive tape or sheet. In more detail, the present invention relates to a water-activated double-sided adhesive tape or sheet which can be preferably used when inserting and fixing a grip on sports equipment such as golf clubs etc., a bicycle handlebar, or the like.

### BACKGROUND ART

Concerning to golf clubs, a grip has been attached to a shaft of the golf club so far and it is popular that the user of the golf club requests the replacement of the grip to a professional dealer or replaces the grip by himself, as necessary. A method for inserting and fixing the grip on the golf club shaft by use of a double-sided adhesive tape is well known. The method includes following steps: for example, winding the double-sided adhesive tape on the rear end part of the shaft; applying volatile organic solvent on the surface of the adhesive tape to swell and liquefy the surface part of the adhesive; inserting a grip from the rear end of the shaft by utilizing slipperiness generated by the liquefaction; and then leaving it as it is to evaporate solvent existing in the surface of the adhesive and fix the grip on the shaft by recovery of an adhesive force of the adhesive.

However, in this method, the user of the golf club cannot use the golf club for a period from the insertion of the grip till drying of solvent. Therefore, it is common to use a highly volatile solvent so that the golf club can be used as soon as possible. But, in the case of using a volatile solvent, when insertion takes much time, the grip is fixed on the shaft in the middle of insertion or before fine adjustment of the grip position after insertion. In this situation, there is a problem that it is necessary to cut and dispose the grip attached, wind the adhesive tape on the shaft again, and insert and fix a new grip. In addition to this, it is necessary to pay attention to safety and environmental aspects because a volatile organic solvent is a dangerous substance.

For solving the problem caused by such volatilization of solvent when using such a volatile organic solvent, a double-sided adhesive tape using water as an activating solvent has been proposed. For example, Japanese Utility Model Laid-Open No. 05-085834 (Patent document 1) discloses a method for inserting and fixing a grip by using a double-sided adhesive tape which comprises a tape-like substrate, an adhesive layer provided on one surface of the tape-like substrate, a water-soluble bonding agent layer which expresses adhesiveness by applying water, on the other surface of the tape-like substrate, and a releasable paper provided on the adhesive layer. In this method, after the releasable paper was stripped from the surface of the adhesive layer, the face coated with the adhesive is stuck to a golf club shaft. After this, water is provided to the surface of the water-soluble bonding agent layer to make it pasty and a grip is inserted and fixed on the shaft. Furthermore, Japanese Patent Laid-Open No. 11-140401 (Patent document 2) discloses a double-sided adhesive tape which comprises a substrate, a pressure-sensitive adhesive layer for adhering the tape to a golf club shaft, which is provided on one surface of the substrate, and an activated bonding agent layer currently known, which can be activated by providing a water-soap mixture or solvents, on the other surface of the substrate. In this double-sided adhesive tape, when the aqueous soap liquid is provided to the activated bonding agent layer after sticking the pressure-sensitive adhesive layer to a golf club shaft, slipping properties are given to the bonding agent layer. Such a double-sided adhesive tape for fixing the grip, which comprises a water-activated adhesive layer, is commercially available. However, when inserting and fixing the grip by use of the conventionally proposed or available double-sided adhesive tapes having a water-activated adhesive layer, there was a problem that a long time is needed till the user can use the golf club after insertion of the grip. In addition to this, there was another problem that the grip cannot be fixed depending on the material thereof.

Another method for inserting and fixing a grip to a golf club shaft by utilizing compressed air is known. In this method, air is injected from the grip end by an air compressor to blow up the grip. The grip blown up is pushed onto the shaft in this state. After fine adjustment of the grip position, injection of air is stopped to make the space between the surface of the shaft and the inner surface of the grip into a vacuum state. By this, the grip is closely fitted to the shaft and fixed. In this method, water may be applied for giving good sliding while insertion, as needed. In this method, as a double-sided adhesive is not used for fixing the grip, no problems when using the double-sided adhesive tape occur. But, it is necessary to use grips which were subjected to special processing in this method. Therefore, grips attachable to the shaft are limited and it is necessary to use a special compressor in this method. Thus, this method lacks versatility and cannot be conveniently utilized by the individual.

The double-sided adhesive tape for fixing a grip of a golf club was mentioned up to here. However, aforementioned problems occur when inserting and fixing a grip on other sports equipment except for a golf club and attaching and fixing a grip to a bicycle handlebar and the like. Furthermore, it goes without saying that these problems occur when using an adhesive sheet instead of the adhesive tape.

### CITED PATENT DOCUMENTS

Patent document 1: Japanese Utility Model Laid-Open No. 05-085834
Patent document 2: Japanese Patent Laid-Open No. 11-140401

### DISCLOSURE OF THE INVENTION

### Problems to be Solved by the Invention

Considering these situation, an object of the present invention is to provide a water-activated double-sided adhesive tape or sheet wherein it is stuck to a shaft when inserting a grip of a golf club or the like, slipperiness is given to an unstuck face by applying water to the unstuck face, a grip can be inserted by utilizing the slipperiness, and early fixing after insertion can be attained.

Another object of the present invention is to provide the aforementioned water-activated double-sided adhesive tape or sheet which can fix the grip regardless of materials of the grip inserted.

### Means for Solving the Problems

As a result of intensive studies and investigations, the present inventors found that the aforementioned objects can be attained by using a water-activated double-sided adhesive tape or sheet which comprises a substrate, an adhesive layer provided on one surface of the substrate, and an water-activated adhesive layer provided on the other surface of the substrate, wherein the substrate is made water-permeable and the adhesive layer provided on one surface of the substrate, which is an adhesive layer near the shaft, is made water-absorbable.

That is, the present invention relates to a water-activated double-sided adhesive tape or sheet described below.

(1) A water-activated double-sided adhesive tape or sheet which comprises a substrate, an adhesive layer provided on one surface of the substrate, and a water-activated adhesive layer provided on the other surface of the substrate, to which slipperiness can be given by applying water, wherein the substrate is a water permeable substrate and the adhesive layer provided on one surface of the substrate consists of a water-absorbing adhesive.

(2) The water-activated double-sided adhesive tape or sheet described in (1) above, wherein the water-absorbing adhesive is an adhesive containing a water-absorbing polymer.

(3) The water-activated double-sided adhesive tape or sheet described in (2) above, wherein the amount of water absorption of the water-absorbing polymer is 20 g/g or more.

(4) The water-activated double-sided adhesive tape or sheet described in (3) above, wherein the water-absorbing polymer is at least one selected from a group consisting of carboxymethyl cellulose and salts thereof, methyl cellulose, hydroxyethyl cellulose, crosslinked polyvinyl alcohol, crosslinked polyethylene glycol, polyacrylic acid, a partially neutralized polyacrylic acid and crosslinked products thereof, and polyethylene oxide.

(5) The water-activated double-sided adhesive tape or sheet described in any one of (1) to (4) above, wherein the water permeable substrate is nonwoven fabric, Japanese paper, or machine-made paper.

(6) The water-activated double-sided adhesive tape or sheet described in any one of (1) to (5) above, wherein the water-activated adhesive layer, to which slipperiness can be given by applying water, contains at least one kind selected from water-soluble or water-absorbing polymers which can give slipping properties by absorption of water.

(7) The water-activated double-sided adhesive tape or sheet described in (6) above, wherein the water soluble or water-absorbing polymer is at least one selected from a group consisting of starch, etherified starch, dextrin, gelatin, cellulose ester, sulfated cellulose, gum arabic, guar gum, carboxymethyl cellulose and salts thereof, methyl cellulose, hydroxyethyl cellulose, polyvinyl alcohol, crosslinked polyvinyl alcohol, polyacrylic acid, partially neutralized polyacrylic acid and crosslinked products thereof, polyethylene glycol, crosslinked polyethylene glycol, polyvinylpyrrolidone, and polyethylene oxide.

### Advantageous Effects of the Invention

Conventionally, double-sided adhesive tapes, on which a grip can be inserted by using water rather than solvent, are known. However, these double-sided adhesive tapes had poor drying properties after insertion and a long drying time was needed. In addition, it was impossible to fix the grip depending on the material of grip even with the lapse of time. On the contrary, the water-activated double-sided adhesive tape or sheet of the present invention can fix the grip on the shaft for a shorter time and more surely than conventionally known water-activated double-sided adhesive tape or sheet without selection of the material of the grip because the drying properties of the grip side adhesive layer is improved using the water-absorbing adhesive as the adhesive on the side of the shaft.

### BRIEF EXPLANATION OF DRAWINGS

FIG. 1 shows schematically a cross section of the water-activated double-sided adhesive tape or sheet of the present invention.

FIG. 2 is a figure in which the water-activated double-sided adhesive tape is vertically adhered on the grip end side of the golf club shaft.

FIG. 3 is a figure in which the water-activated double-sided adhesive tape is spirally adhered on the grip end side of the golf club shaft.

### MODE FOR CARRYING OUT THE INVENTION

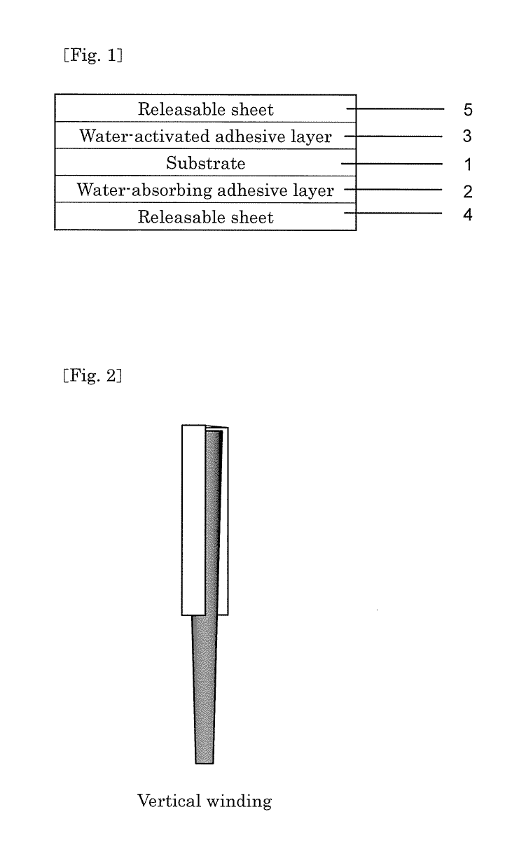

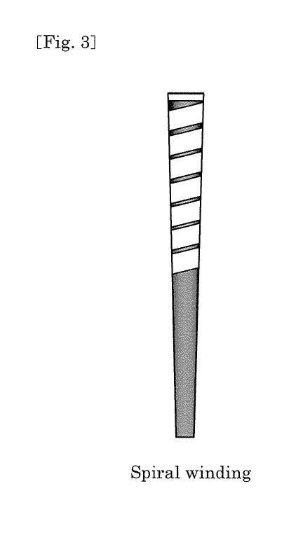

Hereinafter, the water-activated double-sided adhesive tape and sheet of the present invention, which are collectively called sometimes ‘water-activated double-sided adhesive tape’, will be specifically explained while referring to the figures. FIG. 1 is a schematic cross sectional view of the water-activated double-sided adhesive tape of the present invention, and each of FIGS. 2 and 3 is a figure, in which the water-activated double-sided adhesive tape is stuck on the grip end side of the golf club shaft. In addition, as the figures are shown for explaining the present invention, not all sizes and shapes are correctly described in the figures.

The water-activated double-sided adhesive tape or sheet of the present invention can be preferably used when inserting and fixing a grip to sporting goods such as golf clubs etc., a bicycle handlebar, or the like, as described above. As shown in FIG. 1, it has a laminate structure comprising a water permeable substrate 1, a water-absorbing adhesive layer 2 provided on one surface of the substrate, which consist of a water-absorbing adhesive, and a water-activated adhesive layer 3 provided on the other surface of the substrate, which can be activated by water to exhibit slipperiness, and optional releasable sheets 4, 5 provided on the water-absorbing adhesive layer 2 and the water-activated adhesive layer 3 respectively. In addition, it is not necessary to provide the releasable sheet 5 on the water-activated adhesive layer 3 if the water-activated adhesive layer 3 is not formed by a pressure-sensitive adhesive, for example, is formed by a bonding agent, adhesiveness of which is given by applying water, so-called water activated adhesive. Furthermore, it is not necessary to provide the releasable sheet 4 when the water-activated double-sided tape is made available in the market under the state wound, for example. In this case, the releasable sheet 5 can also be omitted when the water-activated adhesive layer 3 is non-adhesive or easily releasable to the water-absorbing adhesive layer 2.

The water-activated double-sided adhesive tape or sheet of the present invention is used as follows, for example. First, the releasable sheet 4 is peeled off and then the water-absorbing adhesive layer 2 is stuck vertically or spirally on an end side of a golf club shaft as shown in FIG. 2 or FIG. 3 or on a grip mounting part of a bicycle handlebar. After this, the releasable sheet 5 is peeled off from the water-activated adhesive layer 3 and then the water is sprayed or applied to the exposed surface of the water-activated adhesive layer 3 to express slipperiness by activation. After a grip is inserted on the shaft end part, that is, grip end, the grip is fixed by drying. Hereinafter, each layer constituting the water-activated double-sided adhesive tape or sheet of the present invention will be sequentially explained specifically.

### [Substrate]

In the water-activated double-sided adhesive tape or sheet of the present invention, it is necessary that water contained in the water-activated adhesive layer migrates to the water-absorbing adhesive layer through the substrate and the migrated water is absorbed to the water-absorbing adhesive layer. Therefore, as the substrate 1, it is preferable to use a substrate through which a large amount of water as possible can smoothly passes. Preferred examples of the good water-permeable substrate include non-woven fabric, Japanese paper, machine-made paper, and the like. The thickness and basis weight thereof are arbitrary and the substrates having, for example, a thickness of about 30 μm to about 100 μm and a basis weight of about 14 g/m² to about 70 g/m² it are usually preferred. As raw fibers for the non-woven fabric, any fibers conventionally used for making non-woven fabric, for example, polymers such as polyester, polyacrylonitrile, cellulose acetate, polypropylene, polyethylene, rayon, and the like, natural fibers such as hemp etc., and other fibers conventionally used for making non-woven fabric can be used.

### [Water-Absorbing Adhesive Layer]

In the water-absorbing adhesive layer 2 which is the greatest feature point of the present invention and is a shaft-side adhesive layer, an adhesive containing a water-absorbing polymer, which is prepared by adding the water-absorbing polymer to the adhesive conventionally known, is preferably used as the adhesive. A pressure sensitive adhesive is preferable as the adhesive, but an adhesive to which adhesiveness is given by applying solvent may be used.

As the water-absorbing polymer contained in the adhesive, any polymers may be used so long as the water-absorption amount of the polymer is 20 times or more its own weight, that is, 20 g/g or more. This water-absorption amount of polymer can be obtained according to the following measuring method on the basis of JIS K7223-1996 ‘Water absorption amount testing method of high water-absorbing polymer: Tea bag method’. That is, first, a predetermined amount of a highly water-absorbing resin is put into a tea bag made by nylon woven fabric and the total weight thereof is weighed. After this, it is immersed in deionized water for a predetermined time. After dewatering of the tea bag, the weight thereof is measured and the water-absorption amount of the resin is calculated from the difference of these weights. Preferred examples of the water-absorbing polymer include, but are not particularly restricted to, natural substance-derived water-absorbing polymer such as carboxymethyl cellulose or salts thereof, methyl cellulose, hydroxyethyl cellulose, polyaspartates and derivatives thereof, polyglutamates and derivatives thereof, and alginates and derivatives thereof; synthetic polymers such as crosslinked polyvinyl alcohol, crosslinked polyethylene glycol, polyacrylic acid, partially neutralized polyacrylic acid and crosslinked products thereof, polysulfonates, salts of maleic anhydride copolymer, polyacrylamide, and polyethylene oxide; and the like. Of these, carboxymethyl cellulose and salts thereof, methyl cellulose, hydroxyethyl cellulose, and resins represented by SAP (Super absorbent polymer), for example, polyacrylic acid, partially neutralized polyacrylic acid, crosslinked products of partially sodium salt of polyacrylic acid, crosslinked polyvinyl alcohol, and crosslinked polyethylene glycol, all of which are highly water-absorbing and easily available. These additives are preferably used as a powder, for example, a powder having an average particle diameter of 100 μm or less.

The amount of the additive is preferably one weight-part to 50 weight-parts in a solid ratio against 100 weight-parts of the adhesive. When the blending amount of the additive is more than 50 weight parts, the adhesiveness may be decreased and when less than one weight-Part, the fixing properties including a time delay till fixing of the grip may be decreased.

Further, the main adhesive agent that is used for constituting the adhesive is not particularly limited, and any main adhesive agents which have been conventionally used for constituting an adhesive can be used. Examples thereof include an acrylic adhesive, a rubber-based adhesive, and a urethane-based adhesive, for example.

Example of the acrylic adhesive includes a copolymer comprising a main monomer, a comonomer which is able to enhance a cohesive force, and a comonomer having a functional group for enhancing adhesiveness and reacting with a crosslinking agent. The copolymer may be crosslinked using a crosslinking agent.

As the main monomer, there are exemplified alkyl acrylates wherein the alkyl group has 2 to 14 carbon atoms, such as n-butyl acrylate, ethyl acrylate, and n-octyl acrylate; and alkyl methacrylates wherein the alkyl group has 4 to 14 carbon atoms, such as isobutyl methacrylate and n-octyl methacrylate. Two or more kinds thereof may be used together.

As the comonomer which is able to enhance cohesive force, there are exemplified methyl acrylate, methyl methacrylate, ethyl methacrylate, propyl methacrylate, styrene, vinyl acetate, acrylonitrile, methacrylonitrile, acrylamide, and the like. Two or more kinds thereof may be used together.

As the comonomer having a functional group for enhancing the adhesiveness and reacting with a crosslinking agent, there are exemplified monocarboxylic acids such as acrylic acid and methacrylic acid; polyvalent carboxylic acids and anhydrides thereof, such as maleic acid and glutamic acid; and carboxylic acid derivatives having a hydroxyl group such as hydroxyethyl methacrylate and hydroxypropyl methacrylate. Two or more kinds thereof may be used together.

The crosslinking agent can be selected from any crosslinking agents which have been conventionally used, such as polyisocyanate compounds, epoxy compounds, melamine resins, urea resins, dialdehydes, and methylol polymers. Of these, polyisocyanate compounds having 2 or more of free isocyanate groups in a molecular are particularly preferred. Examples thereof include aliphatic diisocyanates such as hexamethylene diisocyanate, trimethylhexamethylene diisocyanate, lysine diisocyanate, and trimethylene diisocyanate; alicyclic diisocyanates such as isophorone diisocyanate and cyclohexane diisocyanate; aromatic diisocyanates such as xylene diisocyanate, torylene diisocyanate, diphenylmethane diisocyanate, naphthalene diisocyanate, and biphenylene diisocyanate; trimethylolpropane adducts thereof; a burette form thereof; and trimers having an isocyanurate ring. Two or more kinds thereof may be used together.

The acrylic adhesives may contain a tackifier, a filler material, an oxidation inhibitor, a thickener, a coloring agent, a plasticizer, and other additives, which have been known hitherto as additive agents, as needed. For example, examples of the filler material include clay, calcium carbonate, silicate, aluminum hydroxide, mica, and the like.

The rubber-based adhesive comprises a main component such as a natural rubber, a synthetic rubber, and a regenerated rubber, which are called an elastomer, and additional components comprising a tackifier and an oxidation inhibitor, which are added to the elastomer. Further additives such as a softener, a crosslinking agent, and a filler agent may be added thereto, if necessary.

Examples of the urethane-based adhesive include, for example, a composition comprising a reaction product of a polyol with a multifunctional isocyanate compound and a tackifier added to the reaction compound, oligomers having urethane linkages and terminal (meth)acryloyl groups, and the like.

As the polyol, any polyols can be used without particular restriction as long as these have two or more hydroxyl groups. Examples thereof include, for example, polyether-based polyols and polyester-based polyols.

Further, the oligomers having urethane linkages and terminal (meth)acryloyl groups are obtained by the following methods, for example. A urethane oligomer is formed by reacting an alkylene diol or a diol molecular having hydroxyl groups at the terminal of a polyether compound etc. with a diisocyanate molecular. And then, the terminal functional group of the urethane oligomer is reacted with the compound having a (meth)acroyl group to obtain the oligomer having an urethane linkage and terminal (meth) acryloyl groups. Alternatively, the oligomer having an urethane linkage and terminal (meth) acryloyl can be obtained by reacting a polyether or polyester compound having terminal hydroxyl groups with a compound having a (meth)acryloyl group and an isocyanate group.

The water-absorbing adhesive layer may have an arbitrary thickness and the preferable thickness thereof is 10 μm to 80 μm generally.

### [Water-Activated Adhesive Layer]

The water-activated adhesive layer 3 of the present invention constitutes the grip side adhesive layer and it expresses the slipperiness by liquefaction of the adhesive layer to a viscous fluid-state because of the absorption of water to the additives in the adhesive when water was attached to the surface of the adhesive. As the additives giving such properties, the aforementioned water soluble or water-absorbing polymer which can give the slipping properties by the absorption of water can be used. The water soluble or water-absorbing polymer which is used in the water-activated adhesive layer may be polymers which can give slipperiness to the adhesive layer by the absorption of water. The water-absorbing polymer may be a water-swelling polymer. Examples of the water soluble or water-absorbing polymer include starch, etherified starch, dextrin, gelatin, cellulose ester, sulfated cellulose, gum arabic, guar gum, carboxymethyl cellulose and salts thereof, methyl cellulose, hydroxyethyl cellulose, casein treated with ammonia, glycerol, emulsified wax, polyvinylalcohol, crosslinked polyvinyl alcohol, polyacrylic acid, partially neutralized polyacrylic acid and crosslinked products thereof, polyethylene glycol, crosslinked polyethylene glycol, polyvinylpyrrolidone, polyethylene oxide, and surfactant, for example. These additives are preferably used as a powder, for example, a powder having an average particle diameter of 100 μm or less.

The amount of the aforementioned additive is preferably 10 weight-parts to 100 weight-parts in a solid ratio against 100 weight-parts of the adhesive. When the amount of the additive is more than 100 weight parts or less than 10 weight parts, the fixing properties and insertion properties of the grip may be decreased.

As the adhesive used for constituting the adhesive of the water-activated adhesive layer 3 of the present invention, any conventionally known adhesives can be used like the adhesive used in the water-absorbing adhesive layer 2 and the same main adhesive agent (for example, acrylic, rubber-based, or urethane-based adhesives), the same crosslinking agents etc. as those explained with reference to the adhesive in the water-absorbing layer 2 can be used. In addition, the adhesive used in the water-activated adhesive layer may be a water-activated adhesive, to which water is applied to give adhesiveness by activation. However, a pressure-sensitive adhesive is preferred.

The water-activated adhesive layer may have an arbitrary thickness and the preferable thickness thereof is generally 20 μm to 80 μm.

### [Releasable Sheet]

The releasable sheets 4, 5 are respectively laminated on the water-absorbing adhesive layer 2 and water-activated adhesive layer 3 of the water-activated double-sided adhesive tape of the present invention, as needed. These releasable sheets are used for protecting the water-absorbing adhesive layer 2 and the water-activated adhesive layer 3 for a period until the water-activated double-sided adhesive tape of the present invention is used.

As the releasable sheet used in the water-activated double-sided adhesive tape of the present invention, any releasable sheet conventionally used for protecting the adhesive layer of the adhesive tape or sheet can be used. Examples thereof include a surface-treated release paper with a silicon resin, a releasably surface-treated plastic sheet, a plastic sheet having release properties, etc.

The water-activated double-sided adhesive tape or sheet of the present invention can be prepared as follows, for example. The water-activated adhesive and the water-absorbing adhesive, which are used for the water-activated double-sided adhesive tape or sheet of the present invention, are made from the main adhesive agent, the crosslinking agent, and the aforementioned additives as well as other additives needed for forming the adhesive. The thus prepared water-activated adhesive and water-absorbing adhesive are respectively applied onto different releasable sheets to form a water-activated adhesive layer and a water-absorbing adhesive layer. These water-activated adhesive layer and water-absorbing adhesive layer are stuck on different surfaces of the same substrate in a state of being adhered on the releasable sheet to form a water-activated double-sided adhesive sheet. When a water-activated double-sided adhesive tape is needed, it is manufactured by steps of slit-cutting the double-sided adhesive sheet, optionally peeling off the releasable sheet provided on the water-absorbing adhesive layer, and winding the slit-cut tape. Alternatively, the water-activated double-sided adhesive tape may be manufactured by winding the double-sided adhesive sheet after optionally peeling off the releasable sheet provided on the water-absorbing adhesive layer and cutting the wound adhesive sheet in accordance with a set tape width. In addition, the manufacturing methods of the water-activated double-sided adhesive tape or sheet are not restricted to the methods described above and any methods can be adopted. For example, a method for preparing the water-activated double-sided adhesive sheet by forming a water-absorbing adhesive layer by applying a water-absorbing adhesive to a substrate directly, on the other hand, forming a water-activated adhesive layer by applying a water-activated adhesive onto a releasable sheet, and then sticking the water-activated adhesive layer to the other surface of the substrate having the water-absorbing adhesive layer, i.e. the surface which is not coated with the water-absorbing adhesive; on the contrary, a method for forming a water-activated double-sided adhesive sheet by forming a water-activated adhesive layer on the substrate directly and sticking a water-absorbing adhesive layer, which is provided on a releasable sheet, to the other surface of the substrate having a water-activated adhesive layer; and a method for forming a water-activated double-sided adhesive sheet by directly applying a water-activated adhesive layer and a water-absorbing adhesive layer onto each surface of the substrate respectively to form these layers on the different surface of the substrate may be adopted. As methods for applying an adhesive onto a substrate or a releasable sheet, any application methods conventionally known can be adopted. In addition, as the coating devices, any coating devices conventionally known, for example, a gravure coater, a roll coater, a knife coater, a Mayer bar coater, etc. can be used.

The water-activated double-sided adhesive tape or sheet of the present invention can be used as follows. First, a releasable sheet 4 is peeled off from the water-absorbing adhesive layer 2 if a releasable sheet exists, and then, the water-absorbing layer is stuck to a shaft as shown in FIG. 2 or 3. After this, the releasable sheet on the water-activated adhesive layer 3 is peeled off, and water is provided to the surface of the water-activated adhesive layer to give the water-activated adhesive layer slipperiness by activating the water-activated adhesive layer. A grip is then inserted on the water-activated adhesive layer to which the slipperiness was given and the position of the grip is adjusted. The shaft on which the grip was inserted is dried by leaving it as it is. Thus, the grip is fixed at a predetermined position.

### EXAMPLES

Hereinafter, the invention will be specifically described with reference to Examples and Comparative examples. However, the present invention is not restricted by these examples in any way.

### Example 1

To 100 weight-parts of an acrylic adhesive polymer, which was produced by solution-polymerizing 90 weight-parts of n-butyl acrylate with 10 weight-parts of acrylic acid in ethyl acetate, one weight-part of polyisocyanate (Colonate-L: made by Nippon Polyurethane Industry Co., Ltd.) and 20 weight-parts of polyvinyl alcohol power with a saponification degree of 88 mol % (PVA-205S: made by KURARAY CO., LTD) as a water-soluble resin were added to form a water-activated adhesive which is a grip side adhesive. The adhesive mixture obtained was applied to a releasable sheet, which is surface-treated with a releasing agent, in a dry thickness of 50 μm. After drying, the water-activated adhesive layer obtained was stuck to one surface of nonwoven fabric having a basis weight of 14 g/m² (Mikiron #805: made by Miki Tokusyu Paper MFG. CO. LTD.) which is a substrate.

Further, a shaft side water-absorbing adhesive was produced by adding 20 weight-parts of a crosslinking type polyacrylic acid (JUNLON PW121: made by TOAGOSEI CO., LTD.) in a solid ratio to 100 weight-parts of an acrylic adhesive polymer which was produced by solution-polymerizing 90 weight parts of n-butyl acrylate with 10 weight-parts of acrylic acid in ethyl acetate. The water-absorbing adhesive obtained was applied to a releasable sheet, which is surface-treated with a releasing agent, in a dry thickness of 50 μm. After drying, the water-absorbing adhesive layer obtained was stuck to the other surface of the aforementioned substrate to obtain a water-activated double-sided adhesive sheet.

The grip fixing properties and holding force of the obtained water-activated double-sided adhesive sheet were estimated by performing the grip insertion test and the holding force test according to testing methods described below. In addition, the holding force test was performed for estimating the drying properties of the grip side adhesive. When the holding force is low in the holding force test, it indicates to be slow to dry. Results of the grip insertion test and the holding force test are shown in Table 1.

### <Grip Insertion Test>

(1) A sample prepared in Example is cut into a size of 45 mm×280 mm.
(2) A release paper provided on the surface of the shaft-side water-absorbing adhesive of the cut sample is peeled off and then the surface of the shaft-side water-absorbing adhesive is stuck to a carbon shaft so as to cover the end of the shaft as shown FIG. 2 (longitudinal winding sticking). This process is repeated and two carbon shafts on which the adhesive sheet is respectively stuck are prepared.
(3) After this, a release paper is peel off respectively from the surface of the grip-side water-activated adhesive and water is sprayed over the entire surface of the water-activated adhesive layer with an atomizer.
(4) After spraying water, these are left as it is for one minute and following 2 kinds of grips which are different in hardness are inserted on each carbon shaft.

Golf grip 1 (hard grip): Niion Yellow (made by JAPAN FAWICK Corporation)

Golf grip 2 (soft grip): DD2 Rubber grip (made by JAPAN FAWICK Corporation)

(5) After being left for one day, the grips were twisted by hand to confirm the fixedness. The fixedness is evaluated on the basis of the following evaluation criterion.

### (Evaluation Criterion)

◯: Don't move when twisted by hand.

X: Move when twisted by hand.

### <Holding Force Test>

(1) After peeling off a release paper provided on the surface of a water-absorbing adhesive, polyethylene terephthalate (PET) film with a thickness of 25 μm is stuck thereon and then the sample is cut into a size of 25 mm×150 mm.
(2) A release paper provided on the surface of a grip-side water-activated adhesive of the cut sample is peeled off and then the sample is left in an aquarium, in which water is filled, for one hour in a state that the surface of a grip-side water-activated adhesive contacts with water.
(3) After one minute, it is taken out from the aquarium and stuck on a stainless steel plate with a squeegee.
(4) The stuck sample is cut so that the application area thereof becomes 25 mm×25 mm and then left for 12 hours under the room temperature.
(5) The sample is fixed on the test stand provided by the holding force test of JIS Z 0237 and after applying load of 500 g to the sample, whether the sample dropped or not before the lapse of 24 hours is evaluated on the basis of the following evaluation criteria.

### (Evaluation Criteria)

◯: Didn't drop before the lapse of 24 hours.

X: Dropped before the lapse of 24 hours.

### Example 2

A water-activated double-sided adhesive sheet was prepared in the same manner as in Example 1 except for using sodium carboxymethyl cellulose (DAICEL CMC1120; made by Daicel FineChem LTD.) instead of a crosslinking type polyacrylic acid which is the additive agent of a shaft-side water-absorbing adhesive in Example 1.

The grip insertion test and the holding force test of the water-activated double-sided adhesive sheet obtained were conducted in the same manner as in Example 1 to evaluate the grip fixedness and the holding force thereof. Results are shown in Table 1.

### Example 3

A water-activated double-sided adhesive sheet was prepared in the same manner as in Example 1 except for using methyl cellulose (METLOSE SM-4000; made by Shin-Etsu Chemical Co., Ltd.) instead of a crosslinking type polyacrylic acid which is an additive agent of a shaft-side water-absorbing adhesive in Example 1.

The grip insertion test and the holding force test of the water-activated double-sided adhesive sheet obtained were conducted in the same manner as in Example 1 to evaluate the grip fixedness and the holding force thereof. Results are shown in Table 1.

### Example 4

A water-activated double-sided adhesive sheet was prepared in the same manner as in Example 1 except for using sodium carboxymethyl cellulose (DAICEL CMC1120; made by Daicel FineChem LTD.) instead of polyvinyl alcohol powder which is an additive agent of the grip-side water-activated adhesive in Example 1.

The grip insertion test and the holding force test of the water-activated double-sided adhesive sheet obtained were conducted in the same manner as in Example 1 to evaluate the grip fixedness and the holding force thereof. Results are shown in Table 1.

### Example 5

A water-activated double-sided adhesive sheet was prepared in the same manner as in Example 1 except for using methyl cellulose (METLOSE SM-4000; made by Shin-Etsu Chemical Co., Ltd.) instead of polyvinyl alcohol powder which is an additive agent of the grip-side water-activated adhesive in Example 1.

The grip insertion test and the holding force test of the water-activated double-sided adhesive sheet obtained were conducted in the same manner as in Example 1 to evaluate the grip fixedness and the holding force thereof. Results are shown in Table 1.

### Comparative Example 1

A water-activated double-sided adhesive sheet was prepared in the same manner as in Example 1 except for preparing a shaft-side adhesive without combining a crosslinking type polyacrylic acid which is an additive agent of the shaft-side water-absorbing adhesive in Example 1.

The grip insertion test and the holding force test of the water-activated double-sided adhesive sheet obtained were conducted in the same manner as in Example 1 to evaluate the grip fixedness and the holding force thereof. Results are shown in Table 1.

### Comparative Example 2

A water-activated double-sided adhesive sheet was prepared in the same manner as in Example 1 except for using calcium carbonate (heavy calcium carbonate; made by MARUO CALCIUM CO., LTD.) instead of the crosslinking type polyacrylic acid which is an additive agent of a shaft-side water-absorbing adhesive in Example 1.

The grip insertion test and the holding force test of the water-activated double-sided adhesive sheet obtained were conducted in the same manner as in Example 1 to evaluate the grip fixedness and the holding force thereof. Results are shown in Table 1.

### Comparative Example 3

A water-activated double-sided adhesive sheet was prepared in the same manner as in Example 1 except for using silica (Sylysia 320; made by FUJI SILYSIA CHEMICAL LTD.) instead of the crosslinking type polyacrylic acid which is an additive agent of a shaft-side water-absorbing adhesive in Example 1.

The grip insertion test and the holding force test of the water-activated double-sided adhesive sheet obtained were conducted in the same manner as in Example 1 to evaluate the grip fixedness and the holding force thereof. Results are shown in Table 1.

### Comparative Example 4

A commercially available water-activated double-sided adhesive tape for exchanging the golf grip was used as a water-activated double-sided adhesive tape. The grip insertion test and the holding force test thereof were conducted in the same manner as in Example 1 and the grip fixedness and the holding force thereof were evaluated in the same manner as in Example 1. Results are shown in Table 1.

TABLE 1

| | | | | | Physical |
|---|---|---|---|---|---|
| | | | | | properties of |
| | | Additives for | | | adhesive |
| | Additives for grip- | shaft-side | Grip fixedness | | (Holding |
| | side adhesive | adhesive | Grip 1 | Grip 2 | force) |
| Example 1 | polyvinyl alcohol | crosslinking type | ◯ | ◯ | ◯ |
| Example 2 | powder | polyacrylic acid | | | |
| | | CMC-Na | ◯ | ◯ | ◯ |
| Example 3 | | methyl cellulose | ◯ | ◯ | ◯ |
| Example 4 | CMC-Na | crosslinking type | ◯ | ◯ | ◯ |
| Example 5 | methyl cellulose | polyacrylic acid | ◯ | ◯ | ◯ |
| Comparative example 1 | polyvinyl alcohol | Not added | X | X | X |
| Comparative example 2 | powder | calcium carbonate | X | X | X |
| Comparative example 3 | | silica | X | X | X |

| | | | |
|---|---|---|---|
| Comparative example 4 (Commercially available tape) | ◯ | X | X |

As shown in Table 1, when the double-sided adhesive sheets of Examples 1 to 5 were used, the grips could be fixed by drying of the grip-side adhesive layer in every cases because water attached to and absorbed in the grip-side adhesive was absorbed in the shaft-side adhesive through the substrate by incorporation of the water-absorbing polymer in the shaft-side adhesive.

On the contrary, when the double-sided adhesive sheets of Comparative examples 1 to 3 were used, all of the grips were not fixed after one day passage. It is assumed that water remained in the grip-side adhesive because the shaft-side adhesive could not absorb water contained in the grip-side adhesive. Further, the commercially available adhesive tape has poor drying properties of the grip-side adhesive layer and the soft grip of Grip 2 could not been fixed even after 24 hours. This result showed that the grip could not be fixed depending on the material of the grip.

### DESCRIPTION OF THE REFERENCE NUMBERS

1 Substrate
2 Water-absorbing adhesive layer
3 Water-activated adhesive layer
4,5 Releasable sheet

1. A water-activated double-sided adhesive tape or sheet which comprises a substrate, an adhesive layer provided on one surface of the substrate, and a water-activated adhesive layer provided on the other surface of the substrate, to which slipperiness can be given by applying water, wherein the substrate is a water permeable substrate and the adhesive layer provided on one surface of the substrate consists of a water-absorbing adhesive.

2. The water-activated double-sided adhesive tape or sheet according to claim 1, wherein the water-absorbing adhesive is an adhesive containing a water-absorbing polymer.

3. The water-activated double-sided adhesive tape or sheet according to claim 2, wherein the amount of water absorption of the water-absorbing polymer is 20 g/g or more.

4. The water-activated double-sided adhesive tape or sheet according to claim 3, wherein the water-absorbing polymer is at least one selected from a group consisting of carboxymethyl cellulose and salts thereof, methyl cellulose, hydroxyethyl cellulose, crosslinked polyvinyl alcohol, crosslinked polyethylene glycol, polyacrylic acid, a partially neutralized polyacrylic acid and crosslinked products thereof, and polyethylene oxide.

5. The water-activated double-sided adhesive tape or sheet according to claim 1, wherein the water permeable substrate is nonwoven fabric, Japanese paper, or machine-made paper.

6. The water-activated double-sided adhesive tape or sheet according to claim 1, wherein the water-activated adhesive layer to which slipperiness can be given by applying water contains at least one kind selected from water-soluble or water-absorbing polymers which can give slipping properties by absorption of water.

7. The water-activated double-sided adhesive tape or sheet according to claim 6, wherein the water soluble or water-absorbing polymer is at least one selected from a group consisting of starch, etherified starch, dextrin, gelatin, cellulose ester, sulfated cellulose, gum arabic, guar gum, carboxymethyl cellulose and salts thereof, methyl cellulose, hydroxyethyl cellulose, polyvinyl alcohol, crosslinked polyvinyl alcohol, polyacrylic acid, partially neutralized polyacrylic acid and crosslinked products thereof, polyethylene glycol, crosslinked polyethylene glycol, polyvinylpyrrolidone, and polyethylene oxide.

8. The water-activated double-sided adhesive tape or sheet according to claim 2, wherein the water permeable substrate is nonwoven fabric, Japanese paper, or machine-made paper.

9. The water-activated double-sided adhesive tape or sheet according to claim 3, wherein the water permeable substrate is nonwoven fabric, Japanese paper, or machine-made paper.

10. The water-activated double-sided adhesive tape or sheet according to claim 4, wherein the water permeable substrate is nonwoven fabric, Japanese paper, or machine-made paper.

11. The water-activated double-sided adhesive tape or sheet according to claim 2, wherein the water-activated adhesive layer to which slipperiness can be given by applying water contains at least one kind selected from water-soluble or water-absorbing polymers which can give slipping properties by absorption of water.

12. The water-activated double-sided adhesive tape or sheet according to claim 3, wherein the water-activated adhesive layer to which slipperiness can be given by applying water contains at least one kind selected from water-soluble or water-absorbing polymers which can give slipping properties by absorption of water.

13. The water-activated double-sided adhesive tape or sheet according to claim 4, wherein the water-activated adhesive layer to which slipperiness can be given by applying water contains at least one kind selected from water-soluble or water-absorbing polymers which can give slipping properties by absorption of water.

14. The water-activated double-sided adhesive tape or sheet according to claim 5, wherein the water-activated adhesive layer to which slipperiness can be given by applying water contains at least one kind selected from water-soluble or water-absorbing polymers which can give slipping properties by absorption of water.
